(19) United States
(12) Patent Application Publication
(10) Pub. No.: US 2006/0192307 A1
(43) Pub. Date: Aug. 31, 2006

(54) Method for producing high quality optical parts by casting

(76) Inventors: Eugene Giller, Needham, MA (US); Noa M. Rensing, Newton, MA (US); Paul M. Zavracky, Norwood, MA (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 11/363,560

(22) Filed: Feb. 27, 2006

Related U.S. Application Data
(60) Provisional application No. 60/656,219, filed on Feb. 25, 2005.

(51) Int. Cl. B29D 11/00

(52) U.S. Cl. 264/1.7

(57) ABSTRACT

A casting method, rather than injection molding, to produce polymer optical components and systems is provided. The casting process controls shrinkage and stress, thus providing both high bulk uniformity and high quality, accurate surfaces, by incorporating polymer films into the mold. The films may remain incorporated into the part or may optionally be removed from the part after removal from the mold. In addition, the incorporation of separately produced components within the cast part is also provided, eliminating post-casting assembly manufacturing steps.

### CROSS REFERENCE TO RELATED APPLICATIONS

This application claims the benefit under 35 U.S.C. § 119(e) of U.S. Provisional Patent Application No. 60/656,219, filed on Feb. 25, 2005, the disclosure of which is incorporated by reference herein.

This application is related to U.S. patent application Ser. No. 11/065,847, filed on Feb. 25, 2005, the disclosure of which is incorporated by reference herein.

### STATEMENT REGARDING FEDERALLY SPONSORED RESEARCH OR DEVELOPMENT

N/A

### BACKGROUND OF THE INVENTION

In the last century, polymers have increasingly been used to fabricate low cost, low weight optics, especially in high volume applications that also have less stringent optical requirements. An additional advantage of plastic elements over the more traditional glass is the ease of fabricating non-spherical (aspheric) surfaces, which can simplify the optical design, reduce the number of required elements, or improve the system performance. The use of plastic in more demanding applications, however, has been limited primarily because its optical performance does not yet match that of glass because of poorer surface quality, inhomogeneous bulk properties, or both. A typical problem with molded plastic optics is birefringence due to stress induced in the molding process. One alternative is to combine glass and plastic in the same optical system to take advantage of the properties of glass for high performance components. This has been done in some applications, but designs requiring bonding glass to plastic can be difficult to fabricate, and may not reduce the weight sufficiently. It is thus necessary to develop new approaches to the fabrication of polymer optical parts that maintain the advantages of plastic but match the performance of glass.

One common approach to the fabrication of low cost optics is to form acrylic by injection molding. Acrylic polymer is easy to mold and gives relatively good surface quality. The molding process, however, produces flow lines and stress gradients that result in birefringence and optical index inhomogeneities that distort the image. This effect is a commonly recognized problem for more highly birefringent materials such as polycarbonates, but can be seen in acrylic as well, especially in large or more complex parts or in highly demanding optical systems. The birefringence of acrylic is lower than that of other plastics, although still higher than that of most optical glass. The distortion reduces the resolution of the system below that of the equivalent glass components.

Consider for example an optical system for an eyeglass clip-on display as in FIG. 1, consisting of a compact backlight illuminating a flat panel microdisplay, for example an LCD, and a simple magnifier optical system with long path length. FIG. 2 shows a simple case for the optical system consisting of a solid prism, which may be polymer or glass, with a fold mirror, most commonly at 45°, and a curved surface providing optical power, most simply a plano-convex lens with focal length comparable to but slightly longer than the length of the prism. Optically, this system uses a simple magnifier to create a large virtual image of the display at a comfortable viewing distance and position. Other more complicated optical systems may be also be used. The light path passes laterally through the prism (or eyeglass lens, in the case of an embedded system), entering near the eyeglass temple, traveling through the material, and finally folding toward the viewer in front of the eye. The primary optical power element is placed near the eye, but the system may incorporate field lenses or other auxiliary optical elements as well. This approach places stringent requirements on the optical uniformity of the polymer.

To understand these requirements, consider that a typical pixel size for the display is 12 μm, and the path length through the polymer is 20-30 mm depending on the system's optical design details. Thus the path length through the polymer part is long relative to the requisite resolution. Any variations in the index of refraction among the different possible optical paths within the prism, for example, due to stress in the part, result in differences in the effective optical path length of the paths. This then degrades the focus of the system. The high temperatures and pressures of injection molding technologies are particularly prone to produce stress and flow lies at the corners, edges, and surfaces of the parts. Attempts at standard injection molding by several commercial injection molders have failed to achieve the requisite uniformity in index of refraction. While it is possible to improve the uniformity and control stress by changing the molding conditions, optimizing the bulk properties can, however, result in additional shrinkage at the mold interface, leading to inaccurate surfaces. In the case of clip-on eyeglass displays, deviations from flatness in the flat parallel sides of the light pipe degrade the quality of the view of the external scene through the pipe, resulting in an effective occlusion in the wearer's peripheral vision.

Using techniques known in the art, it is possible to fabricate a polymer optical system with the necessary high resolution. FIG. 3 shows such a system comprising a solid prism or light pipe with an input surface, a 45° surface supplied with a reflective coating, and an output surface at 90° to the input surface and facing the eye of the user. The output surface and the back surface of the pipe parallel to the output surface and offset from it are made transparent and highly flat to allow the user to see through the light pipe with an unimpeded view. The other two surfaces of the pipe, parallel to each other and at 90° to both the input and output surfaces may be optionally transparent, diffuse, or opaque. The prism or light pipe can be mechanically fabricated from larger polymer pieces, which may be produced by a number of methods known to produce highly homogeneous, low stress material. Injection molding may be used to produce the larger polymer blank, since the fabrication process removes the highly stressed or otherwise flawed material near the molded surfaces and edges. Since the prism is mechanically fabricated and either mechanically or chemically polished, the shape and surface quality of the larger part do not matter. The optical power is provided by a separate optical lens element comprising a curved surface that refracts the light emitted from the display and an opposing flat side that is cemented or otherwise attached to the output surface of the prism adjacent to the fold mirror in a separate fabrication step. This lens element may be produced by injection molding or another process known in the art. The optical path through the lens material is short and therefore bulk inhomogeneities are less critical, and the established processes are capable of producing accurate surfaces with acceptable quality.

However, processes currently known in the art cannot simultaneously produce an optical part with a uniform bulk index of refraction free of birefringence, a 45° fold surface, and geometrically accurate, high quality optical surfaces with good mechanical properties. The incorporation of the aspheric lens in the fabrication of what otherwise was a flat component (eyeglass lens or pipe) tightens the constraints on the quality of the flat surface as well. The addition of a protruding lens makes polishing and/or lamination difficult, and introduces a requirement that the surface meet its flatness requirement without post-processing.

### SUMMARY OF THE INVENTION

A further promise of molded plastic optics, however, is the ability to manufacture complicated shapes with protrusions or surface discontinuities. It is desirable to develop a process capable of casting a monolithic system, consisting of a structure with generally parallel faces except for a protrusion that forms the magnifying lens surface. The monolithic process would present an improvement in quality and cost.

This invention relates to methods for fabricating optical systems either from cast polymers or from cast polymers with embedded elements. It addresses the requirement for producing complex shaped parts that have simultaneously low internal stress and high quality optical surfaces.

The present invention addresses the need to achieve good bulk homogeneity while maintaining high surface qualities such as accurate geometry, mechanical hardness, and optical polish. The present invention addresses the complication of fabricating parts with protrusions, as well as the need to decouple the bulk index uniformity from the surface quality of the finished part.

The present invention pertains to methods for producing prisms and complete optical systems by casting polymers. The casting process typically uses lower pressures and temperatures than injection molding, resulting in lower stress and shrinkage than injection molding. The methods described herein produce parts with highly uniform bulk optical properties as well as highly polished flat or curved surfaces and/or protrusions as required by the optical design. In addition the parts may incorporate other optical elements previously fabricated by casting, cutting, molding, or other methods. The methods described herein offer an innovative approach to achieving parts with a highly uniform bulk index of refraction as well as highly polished geometrically accurate surfaces, which may optionally include protruding elements. This method can be used to manufacture clip-on light pipes or embedded optical systems such as described in U.S. Pat. Nos. 6,023,372 and 5,886,822. Here we describe modifications to the casting approach that allow the casting of more complicated shapes while at the same time reducing or eliminating expensive post processing or assembly steps.

### DESCRIPTION OF THE DRAWINGS

The invention will be more fully understood from the following detailed description taken in conjunction with the accompanying drawings, in which:

FIG. 1 illustrates a prior art optical engine for clip-on eyeglass display, comprising backlight, LCD display, light pipe, fold mirror, and cemented lens;

FIG. 2 illustrates a prior art light pipe and lens assembly;

FIG. 3 is an exploded view of a prior art light pipe assembly fabricated from an optical light pipe, a separately molded lens, and optical cement;

FIG. 4 illustrates an exploded view of upper and lower mold parts and lens insert according to the present invention;

FIG. 5A illustrates a casting mold for a light pipe with parallel top and bottom optical surfaces according to the present invention;

FIG. 5B illustrates a casting mold for monolithic fabrication of light pipe assembly, with corresponding cavity for an optical element in an upper mold part according to the present invention;

FIG. 6 illustrates a method of forming a cavity in an upper mold part by applying heat and pressure to form it against a positive shaping element according to the present invention;

FIG. 7A illustrates a casting mold lined with barrier film according to the present invention;

FIG. 7B illustrates a cast part with films, which may optionally peel off the finished cast part;

FIG. 8 illustrates a prepared mold with an inserted film not yet shaped to conform to the mold;

FIG. 9 illustrates a prepared mold with a film shaped to conform to the mold prior to the introduction of casting resin;

FIG. 10 illustrates film pouches to be inserted into the mold prior to the introduction of casting resin according to the present invention; and

FIG. 11 illustrates fabrication of a cast part utilizing pouches previously filled with casting resin and sealed prior to the insertion of the pouch into the mold according to the present invention.

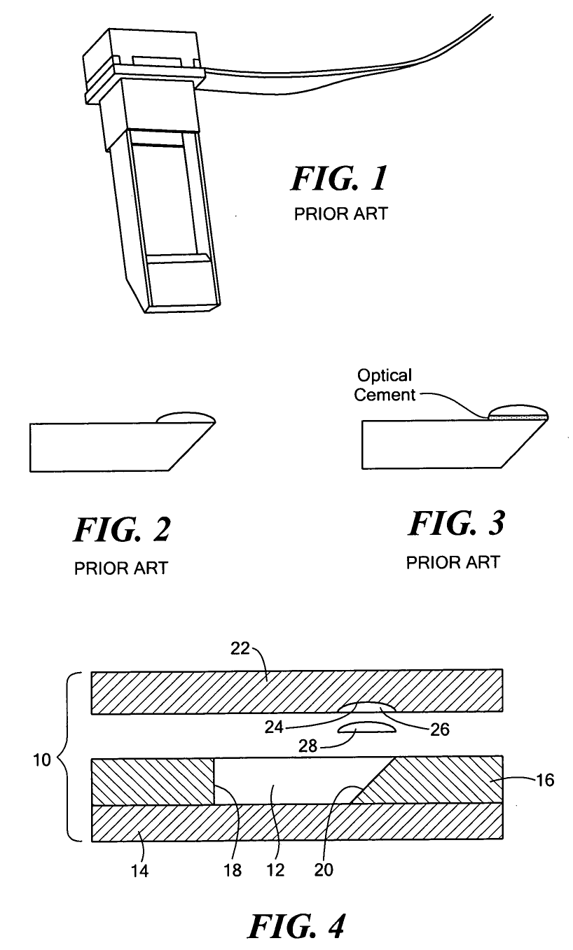

### DETAILED DESCRIPTION OF THE INVENTION

In the present invention, the difficulties of creating optical systems with protruding lenses on otherwise flat surfaces are overcome. Three method embodiments are presented. The first embodiment has optical elements including lenses, mirrors, etc. incorporated into the mold prior to filling. The second embodiment creates a low use mold from a non-machinable molding plate. The third embodiment incorporates films into the mold. Each embodiment is detailed below.

In a first embodiment of a method according to the present invention, optical elements are anchored in a mold. Thus, the mold is designed to hold one or more external optical elements such as mirrors or previously produced lenses. The external optical elements may be injection molded, polished, or produced by any other manner known in the art, prior to their placement in the mold and the introduction of a casting medium. The external optical element may, for example, be an injection molded acrylic lens, which may be placed in a recess within the mold, the recess being shaped to fit a portion of the external element. The purpose of incorporating the elements into the casting mold is to attach them to the external surfaces of the cast part while avoiding the need to cement them at a later step. This may result in less expensive, more accurate, and more durable optical systems.

FIG. 4 illustrates a mold assembly 10 having a mold cavity 12 defined by a bottom element or plate 14, a spacer element 16 shaped to provide the input surface 18 and the 45° fold surface 20, and an upper element 22 that shapes the output surface 24 of the light pipe. The upper element contains a recess or indentation 26 shaped to accept a previously fabricated external element 28 to provide optical power, for example a lens. Upon polymerization, a casting medium in the cavity defined by the bottom, spacer, and upper elements permanently adheres to the exposed surface of the optical element.

The external optical element 28 may be held in place in the mold using a variety of methods including but not limited to gravity, vacuum, or temporary (removable) adhesive. The attachment method is designed to preclude the flow of the casting medium to the external side of the lens, for example due to wicking or vacuum. Alternatively, the sensitive surface of the external element may be protected, for example with tape or other protective layer, which may, for example, be applied as a liquid or vapor and allowed to solidify either prior to the introduction into the mold or after placement in the mold. The casting medium would then adhere only to the exposed surfaces of the lens upon solidification in the mold. A protective film may be kapton tape or other protective adhesive tape known in the art. Protective coatings may, for example, be Teflon-based coatings such as are commercially used for the coating of ophthalmic lenses, which may be vapor deposited or dip coated. Other vapor deposited and/or liquid coating formulations with low adhesion to the liquid polymer medium are also known in the art. These coatings prevent the casting medium from adhering to and permanently contaminating the external optical component. In the case of liquid or vapor deposited protective coatings, it is important that the side of the part adjacent to the casting medium be kept clean of the coating to prevent interfering with the bond to the cast portion of the system.

In a further embodiment, alternative mold materials are used. A casting process of the present inventors described in U.S. patent application Ser. No. 11/065,847, filed on Feb. 25, 2005, for fabricating flat parallel faces utilizes polished polycarbonate plates for the faces of the mold. This is convenient because polycarbonate sheets with a suitable finish are readily commercially available and release easily from the cast polymer, often without the need for additional mold release agents. Also, the process of casting against polycarbonate does not require the use of temperatures that are higher than the Tg (glass transition temperature) of most polymers.

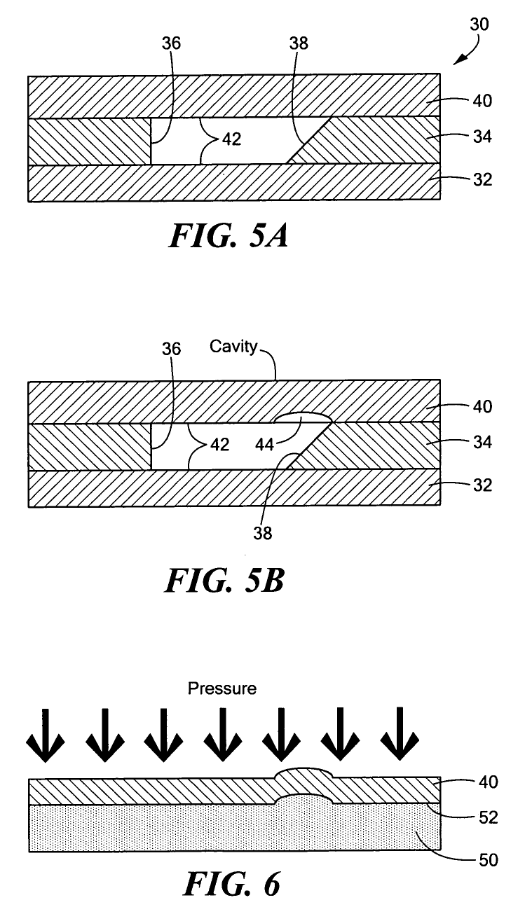

FIG. 5A shows a mold assembly 30 for producing flat faced light pipes. The mold has a lower element 32, a spacer element 34 shaped to produce the input and fold mirror surfaces 36, 38 of the light pipe, and an upper element 40. The upper and lower mold elements have optically polished flat surfaces 42. The polished surfaces are replicated in the finished part to produce the output surface and opposing surface of the light pipe. To add a protrusion to the optical part, a corresponding recess or indentation 44 is formed in the mold assembly, as shown in FIG. 5B, using reference numerals corresponding with FIG. 5A for like parts. The mold has a lower element 32 with a polished flat surface 42, a spacer shaped 34 to produce the input and fold mirror surfaces 36, 38 of the light pipe, and an upper element 40. The upper element has a polished flat surface 42 corresponding to the see-through portion of the light pipe and a shaped recess or indentation 44 corresponding to the optical power element of the light pipe assembly. Ideally, this indentation would have the surface finish desired in the finished part. This is a challenge in a polycarbonate mold element because cutting, including diamond-turning, usually results in poor surface finish and polycarbonate is difficult to polish. Thus, an alternative to cutting the indentation is to form the mold part 40 against a positive 50 of the desired shape, as in FIG. 6. This entails, for example, forming a sheet of polycarbonate against a metal or glass surface 52 of the desired positive shape by one or a combination of methods which may include but are not limited to heating, pressing, or vacuum forming. The positive element 50 can be made of a material that is easy to polish. It is also possible to create a positive metal form of the final desired shape and then compression mold a polycarbonate or other polymer mold from it. Another approach involves injection molding or casting the polycarbonate mold. The life of the shaped polycarbonate mold part is generally shorter than that of traditional molds, however. Thus, a new mold part must be produced regularly to replace the worn mold part.

In a further embodiment of the present invention, a film is incorporated into the molding process. Many preferred casting materials for optical components have low shrinkage and good adhesion, but because of this do not release easily from many of the materials that may be chosen for fabricating molds, such as glass, acrylic, steel, nickel plated steel and others. Accordingly, the present invention expands the mold options by decoupling the surface properties from the bulk properties of the part.

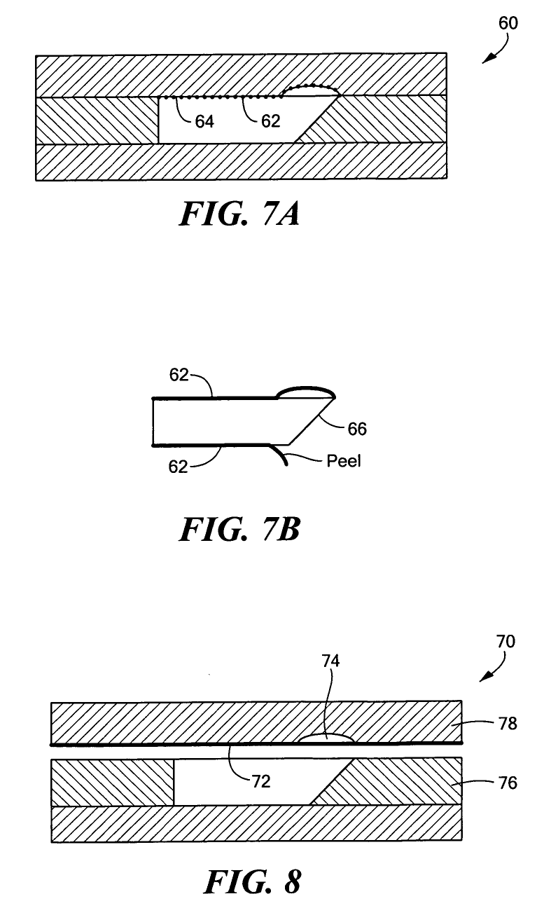

One method is by casting with a barrier film between the cast material and the mold. FIG. 7A shows a mold assembly 60 lined with a film 62 on one molding surface 64. The film may be shaped to the mold either prior to the introduction of the casting medium or during the molding process. As it starts out and remains in the solid state, it does not adhere to the mold but remains with the part after unmolding the part from the mold. If desired, the film can be peeled off the part after unmolding. FIG. 7B shows films 62 adhered to two surfaces of the fabricated and unmolded part 66 and being peeled from one surface. In general, this process allows the fabrication of parts with fewer compromises between the optical or mechanical properties of the bulk material and the surface properties. Integrating the film into the finished part may have other desirable effects. The mechanical and optical properties of the surface can be provided by the film while the cast material can be engineered to optimize the bulk properties. Specifically, the bulk material can be optimized for low stress and high optical uniformity, even if the material cannot form a suitable surface, either because it is too soft for the intended application, or if it won't adequately replicate the mold surface. If the films are sufficiently rigid, the bulk material may be a gel or even a liquid.

The film or membrane used for this effort must be robust enough to survive the handling required to place it into the mold without folds, tears, or wrinkles, and flexible enough to stretch to completely conform to the desired shape. Upon demolding, it must not induce stress in the bulk material. In addition any tendency to flow over time, induce flow in the bulk, or delaminate from the bulk must be avoided. In the preferred method, the film is stretched to conform to the mold. This stretching may introduce strain and birefringence, but its impact on the overall optical resolution of the part is minimal since the film thickness, and therefore the optical path through the film, is short.

The film must be optically clear. It is further desirable that the index of refraction of the film either match that of the bulk material, or, preferably be slightly lower to provide antireflection properties.

If the film is to remain integrated into the finished part, the interface between the film and the cast compound must be optically clear and resistant to delamination. It is possible to pretreat the films with coupling agents to enhance adhesion and reduce delamination. Some coupling agents include:

3-aminopropylmethyldiethoxysilane,

3-glycidyloxypropyltrimethoxysilane,

vinyltriethoxysilane,

3-mercaptopropyltrimethoxysilane,

3-isocyanatopropyltriethoxysilane,

triphenyl borate,

trimethoxyboroxine,

tetracresyl titanate,

tetra-2-ethylhexyl titanate,

zirconium tetra-2-ethylhexanoate,

tetraphenoxy zirconate, and

tetra-2-ethylhexylzirconate.

The material used in the films may have significantly better mechanical and chemical properties than would otherwise be achievable. These properties may include abrasion resistance and resistance to moisture and chemical attacks. This is desirable as it allows the optics to be used in environments and applications that may otherwise be too aggressive. In addition the film may have an antireflective coating, hardcoating, anti-smudge coating and/or polarization dependent properties. For example, coatings are commonly available on substrate films including polycarbonates such as Lexan film, cast and extruded polyurethane films, and fluorinated polymer films such as Teflon AF11 and Cytop12. To be effective the coating must not fracture from the stresses introduced in the molding process; this may require the modification of standard coating processes, such as by using thinner layers or lower temperatures.

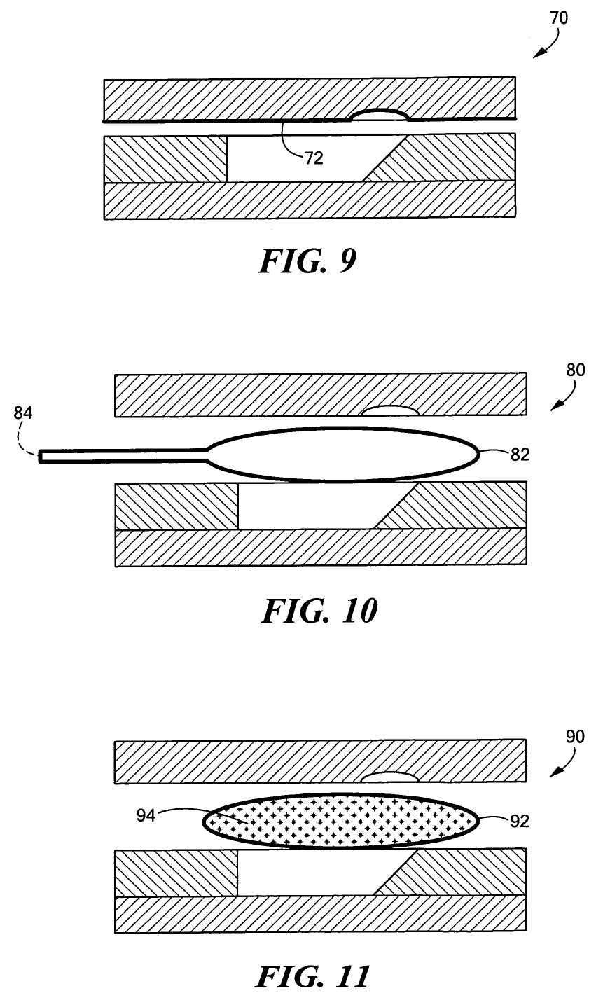

The barrier film 72 may be anchored in or to the mold assembly 70 prior to introducing the liquid optical polymer, as shown in FIG. 8. A liquid polymer casting compound would then be introduced under a pressure differential, stretching the film into the lens recess 74 and completely filling the mold. A suitable opening (not shown) may be formed in the mold assembly 70, for example, through the spacer element 76, to allow the introduction of the casting compound. Various methods of inserting, attaching, or anchoring the film or membrane in the mold are possible. One approach is to clamp the film in the mold. Subsequently, a pressure difference is generated between the film and the mold so that the film completely conforms to the mold. The upper mold element 78 may be made porous in order to facilitate generating a pressure difference. The pores or other openings used to generate the pressure difference must be shaped in a suitable way to avoid leaving impressions on the critical surfaces of the optical part. The anchoring method must prevent any casting material from seeping between the film and the mold, as that would deform the part and may permanently damage the mold. Alternatively, the film 72 could be shaped to the mold assembly 70 prior to filling it, for example by air or gas pressure or with a complementary shaped tool. See FIG. 9. Another approach shown in FIG. 10 is to create a pouch 82 from the film membrane. The pouch is sealed except for an opening 84 through which the casting resin is introduced after the pouch is inserted into the mold assembly 80. The pouch can be made to conform to the mold using a pressurized gas forming process such as blow molding. The gas can be introduced through the opening provided for the casting resin or through a separately provided opening. Alternatively, the pouch can be expanded during the process of filling with the liquid polymer resin. The pressure of the casting compound then causes the film to conform to the mold in a manner similar to blow molding. In yet another alternative, shown in FIG. 11, sealed pouches 92 can be pre-filled with the casting resin 94 and inserted into the mold assembly 90 for final shaping and curing, similar to compression molding. An advantage of this approach is that the casting resin can be handled in a very clean environment, reducing the risk of contamination or inclusions. For this approach the casting resin must be chosen so that polymerization can be initiated at the appropriate time, for example by the use of UV radiation or thermal energy.

The films can also be preformed to the mold surface by the vacuum forming, blow-molding, or heat fitted with an additional insert to conform the mold surface. An alternative to solid films is to form a film on the mold by vapor phase deposition, dipping or spin coating. Since this coating will be thin, its composition can be chosen to optimize the surface quality with reduced concern as to its bulk optical properties. Furthermore, the stress in this layer will not be as great as in a more highly constrained system.

The film should conform to the mold sufficiently to replicate the desired surface features, including for example the aspheric shape of the magnifying optic discussed above, and a small radius inside corner at the junction between the lens and the flat surface of the light pipe. However, it may not be desirable to reproduce the roughness of the surface of the mold. The tension in a solid film can provide a planarization effect leading to smoother optical surfaces. Alternatively, if a rough mold were to be coated with a liquid film that does not remain with the cast part (adhering to the mold or peeling off) the surface tension of the free surface of the liquid coating could provide the necessary planarization. This permits the mold to be made to a coarser, and consequently less expensive, surface finish specification. For example, it may be possible to machine a steel mold using ordinary CNC machine tools rather than diamond turning, or it may be possible to forgo one or more polishing steps in the preparation of the mold. If the smoothing effect of the film is sufficient, it may also be possible to mold optical quality parts using a mold made by a rapid prototyping method such as SLA. Furthermore, the planarization effect of the film may allow a porous mold component to be used, for example for the purpose of vacuum forming the films. The component may be made porous by drilling or otherwise cutting ducts into the components, or by the use of a porous material such as sintered metal, or by other means known in the art. The tradeoff between accurate reproduction of small surface details and a desirable surface smoothing effect leads to a specification on the formability of the film, which may be different for different parts.

The desired film properties may best be defined using known methods of finite element computer modeling or other numerical calculations, as would be known in the art. These calculations use the film thickness, pressure differential across the film, maximum size of pore or other imperfection in the mold surface, and mechanical tension in the film, along with mechanical properties such as compliance to derive the maximum deviation from the prescribed surface geometry. The maximum allowable surface deviation (irregularity) may be calculated using optical modeling computer programs such as ZEMAX, OSLO, Code V, or any other suitable software. This information may then be used to optimize the selection of film for lining the mold cavity.

What is claimed is:

1. A method of producing a solid optical system having a protruding optical element, the element providing optical power, comprising:
providing a mold assembly having a mold cavity, the mold assembly including a recess in one surface shaped to receive the protruding optical element;
introducing an optical material into the mold cavity, at least a portion of the optical material comprising an optical polymerizable casting compound and a further portion of the optical material disposed within the recess to form the protruding optical element; and
curing the polymerizable casting compound to provide an optical component; and
removing the optical component from the mold assembly.

2. The method of claim 1, wherein the further portion of the optical material forming the protruding optical element comprises a lens formed prior to the step of intruding the optical material into the mold cavity.

3. The method of claim 2, wherein the protruding optical element is held in the recess by vacuum, gravity, or a temporary adhesive.

4. The method of claim 2, wherein an outer surface of the protruding optical element is protected with a layer of a protective material.

5. The method of claim 4, wherein the protective material is applied as tape.

6. The method of claim 4, wherein the layer of protective material is applied as a liquid.

7. The method of claim 4, wherein the layer of protective material is applied as a vapor.

8. The method of claim 1, wherein the mold assembly comprises faces comprised of polished polycarbonate plates.

9. The method of claim 8, wherein the polished polycarbonate plates comprise opposed surfaces.

10. The method of claim 1, wherein at least a portion of the mold assembly comprises optically polished flat surfaces.

11. The method of claim 1, wherein the mold assembly comprises a lower element, an upper element, and a spacer element between the lower element and the upper element.

12. The method of claim 1, wherein the spacer element includes a surface shaped to produce an input face into a light pipe and a further surface shaped to produce a fold mirror surface at an end of the light pipe opposite the input face.

13. The method of claim 1, wherein the recess is polished with a surface finish.

14. The method of claim 1, wherein the recess is formed in the mold assembly by forming a sheet of polycarbonate against a surface having a positive shape.

15. The method of claim 14, wherein the sheet of polycarbonate is formed against the positive shape by heating the polycarbonate.

16. The method of claim 14, wherein the sheet of polycarbonate is formed against the positive shape by pressing the polycarbonate.

17. The method of claim 14, wherein the sheet of polycarbonate is formed against the positive shape by vacuum forming.

18. The method of claim 14, wherein the positive shape is formed in a metal or glass surface.

19. The method of claim 1, wherein the mold assembly is formed of a polymer compression molded from a positive metal form having a shape corresponding to a desired finished part.

20. The method of claim 1, wherein the mold assembly comprises a injection molded or cast polycarbonate.

21. The method of claim 1, wherein at least a portion of the cavity in the mold assembly is lined with a film material.

22. The method of claim 21, wherein the film is shaped to the mold cavity prior to introduction of the casting compound into the mold cavity.

23. The method of claim 21, wherein the film is shaped to the mold cavity during introduction of the casting compound into the mold cavity.

24. The method of claim 21, wherein the film is removed from the optical component after the optical component is removed from the mold.

25. The method of claim 21, wherein the film remains in the mold when the optical component is removed from the mold.

26. The method of claim 21, wherein the casting compound is selected to optimize bulk mechanical and optical properties of the optical component, and the film is selected to optimize mechanical and optical properties of the surface of the optical component.

27. The method of claim 26, wherein the casting material is optimized for low stress and high optical uniformity.

28. The method of claim 21, wherein the casting compound comprises a solid when cured.

29. The method of claim 21, wherein the casting comprises a gel or a liquid when cured and the film is sufficiently rigid to retain the gel or the liquid.

30. The method of claim 21, wherein after curing the casting compound is softer than the film.

31. The method of claim 21, wherein the film has an index of refraction equal to or lower than an index of refraction of the casting compound when cured.

32. The method of claim 21, wherein a coupling agent is provided between the film and the casting compound.

33. The method of claim 21, wherein the film is optically clear.

34. The method of claim 21, wherein the film provides abrasion resistance.

35. The method of claim 21, wherein the film provides moisture resistance.

36. The method of claim 21, wherein the film provides resistance to chemical attack.

37. The method of claim 21, wherein the film provides an anti-reflection coating.

38. The method of claim 21, wherein the film provides a hard coating.

39. The method of claim 21, wherein the film provides an anti-smudge coating.

40. The method of claim 21, wherein the film provides polarization-dependent properties.

41. The method of claim 21, wherein a pressure difference is created between the film and a mold surface, wherein the film conforms to the mold surface.

42. The method of claim 21, wherein the mold assembly at least adjacent the mold surface is porous.

43. The method of claim 42, wherein the film is shaped to the mold surface with air or gas pressure.

44. The method of claim 21, wherein the film is shaped to the mold surface with a complementary shaped tool.

45. The method of claim 21, wherein the film comprises a pouch having an opening therein, the film is placed in the mold cavity, and the casting compound is introduced into the pouch.

46. The method of claim 21, wherein the film comprises a pouch filled with the casting compound, the pouch is placed in the mold cavity, and shaped within the mold cavity.

47. The method of claim 21, wherein the film is formed to a mold surface by vacuum forming.

48. The method of claim 21, wherein the film is formed to a mold surface by blow molding.

49. The method of claim 21, wherein the film is formed to a mold surface by heat fitting with an insert conforming to the mold surface.

50. The method of claim 21, wherein the film is formed by vapor phase deposition.

51. The method of claim 21, wherein the film is formed by dip coating.

52. The method of claim 21, wherein the film is formed by spin coating.

53. The method of claim 21, wherein the film is applied as a liquid having a surface tension that compensates for surface roughness of a mold surface of the mold assembly.

54. The method of claim 21, wherein the film remains on the optical component after the optical component is removed from the mold assembly.

55. The method of claim 21, wherein the film remains in the mold assembly after the optical component is removed from the mold assembly.

56. The method of claim 21, wherein the film is removed from the optical component after the optical component is removed from the mold assembly.

57. The method of claim 21, wherein the film is smoother than the surface of the mold assembly.

58. The method of claim 1, wherein the mold assembly is comprises of glass, acrylic, steel, or nickel plated steel.

59. The method of claim 1, wherein the mold assembly is made by a rapid prototyping method.

60. The method of claim 1, wherein the mold assembly is comprised of a sintered metal.

61. The method of claim 1, wherein the mold assembly is comprised of a polycarbonate.

62. The method of claim 61, wherein the mold assembly is disposable.

63. The method of claim 61, wherein the mold assembly is reusable for a limited number of cycles.

64. An optical component having uniform bulk optical properties and highly polished optical surfaces and incorporating a protruding optical element formed by the method of claim 1.
